(19) United States
(12) Patent Application Publication
(10) Pub. No.: US 2022/0382511 A1
(43) Pub. Date: Dec. 1, 2022

(54) CONVERSATIONAL MARK-UP IN EMBODIED AGENTS

(71) Applicant: Soul Machines Limited, Auckland (NZ)

(72) Inventors: Mark SAGAR, Auckland (NZ); Alistair KNOTT, Dunedin (NZ); Rachel LOVE, Auckland (NZ); Robert Jason MUNRO, Auckland (NZ)

(21) Appl. No.: 17/621,636

(22) PCT Filed: Jul. 9, 2020
(86) PCT No.: PCT/IB2020/056465

§ 371 Date: Dec. 21, 2021

(30) Foreign Application Priority Data
Jul. 9, 2019 (NZ) 755254

(51) Int. Cl. G06F 3/16; G06F 40/253

(52) U.S. Cl. CPC G06F 3/167; G06F 40/253; G06F 2203/011

(57) ABSTRACT

A Markup System includes a Rule Processor, and a set of Rules for applying Markup to augment the communication of a Communicative Intent by an Embodied Agent. Markup applied to a Communicative Utterance applies Behaviour Modifiers and/or Elegant Variations to the Communicative Utterances.

### TECHNICAL FIELD

Embodiments of the invention relate to on-the-fly animation of Embodied Agents, such as virtual characters, digital entities, and/or robots. More particularly but not exclusively, embodiments of the invention relate to the automatic application of Markup and/or Elegant Variations to representations of utterances to dynamically animate Embodied Agents.

### BACKGROUND ART

Behaviour Markup Language, or BML, is an XML-based description language for controlling verbal and nonverbal behaviour for “Embodied Conversational Agents”. U.S. Pat. No. 9,205,557B2 discloses a method for generating contextual behaviors of a mobile robot. A module for automatically inserting command tags in front of key words is provided. Automatic on-the-fly augmentation and/or modification of communicative utterances by embodied, autonomous agents remains an unsolved problem. Further, animating Embodied Agents in a manner that is realistic and non-repetitive remains an unsolved problem. U.S. Pat. No. 9,812,151B1 discloses generating a BML for a virtual agent during a dialogue with a user. However, Embodied Conversational Agents controlled by BML in the prior art are not autonomous agents, and do not have internal states which may conflict with Markup expressing behaviour.

### OBJECT OF INVENTION

It is an object of the invention to improve conversational mark-up in embodied agents, or to at least provide the public or industry with a useful choice.

### BRIEF DESCRIPTION OF DRAWINGS

FIG. 1 shows a system for controlling an expression of a Communicative Utterance by an Embodied Agent; and

FIG. 2 shows a system for bottom-up and top-down control of Embodied Agent behaviour.

### DISCLOSURE OF INVENTION

A Markup System includes a Rule Processor, and a set of Rules for applying Markup to augment the communication of a Communicative Intent by an Embodied Agent. Markup applied to a Communicative Utterance applies Behaviour Modifiers and/or Elegant Variations to the Communicative Utterances.

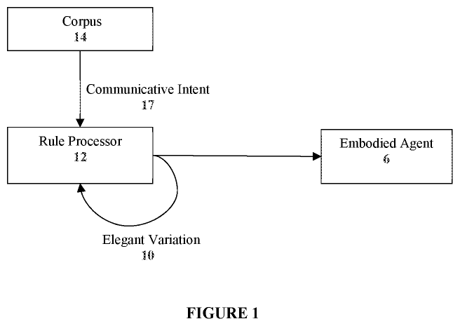

FIG. 1 shows a system for controlling an expression of a Communicative Utterance by an Embodied Agent. A representation of a Communicative Intent (which may be a representation of a Communicative Utterance 18) is received by a Rule Processor 12. The Rule Processor 12 applies Behaviour Modifiers and/or Elegant Variations to generate Markup of a Communicative Utterance corresponding the Communicative Intent. The Communicative Utterance is received by the Embodied Agent 6 which may use a TTS system to communicate the Communicative Utterance, applying any Behaviour Modifiers. A Communicative Utterances is defined broadly to include a unit of method of communication (or combination thereof) such as words, gestures, sign language, or even certain sounds (such as a sigh which communicates frustration).

Behaviour Modifiers refer to how Communicative Utterances are expressed, and may be defined using Markup. Behaviour Modifiers may define any aspect of how Communicative Utterances are communicated, such as how they sound, or which gestures or body language accompany the Communicative Utterances. Some Behaviour Modifiers double as Communicative Utterances, in that they can be expressed by themselves as a Communicative Utterance (e.g. a sign or a yawn), or they can accompany another Communicative Utterance as a Behaviour Modifiers. For example, an Agent may be signing or yawning whilst the agent is speaking. Elegant Variations of a Communicative Utterances are different alternatives of a Communicative Utterance which convey the same or a similar idea or Communicative Intent. Variation in an Embodied Agent's Communicative Utterances prevents the conversation from becoming repetitive, and may be particularly useful for common phrases like greetings and fallbacks.

Rules

Rules are defined to automatically apply Elegant Variations and/or Markup to a Communicative Utterance. Rules may be defined to include a: Target, Priority, Condition and/or Result Markup (which may dictate the insertion of Markup and/or Elegant Variation). Rules may be declared and stored in any suitable manner. For example, rules may be declared in an externally loaded .json file, specifying the targets to which the rules are to be applied and the markup to be applied in each case. An example of a declared rule in json is:
“Description”: “my rule 1”,
“Priority”: 1,
“Target”: “hello”
“Condition”: “@FTRSTWORD(&T)”,
“Markup”: “#PuncHeadNod &T”

Rules can be adjusted as necessary to reflect new Corpus content, changes to Behaviour Modifiers and to differentiate between Embodied Agent personality types.

Targets

Rules apply to Behaviour Modifiers and/or Elegant Variation to Targets. A Rule may identify any suitable Target including: Specific words, Dictionary words, Phrases, Sentences, Acoustic Features. Single-Target Rules search for Targets in the Communicative Utterance and apply the Result to every instance of the Target. “Target”: “Hello”. Multiple Targets may be defined, for example, separated by an OR symbol, e.g. “Target”: “try do my best attempt”. The Result of the rule may apply beyond the Target, for example, to surrounding words, or to the sentence as a whole.

Result

The Result of the rule is the Behaviour Modifier and/or Elegant Variations which the Rule applies to Communicative Utterances containing the Target. The Result may be represented using Markup as described herein. As one example, in the following rule, the Result is Markup with start and stop Tags which applies to the entire sentence within which the rule as found, as denoted by the &s symbol:
“Description”: “sentence targets”,
“Priority”: 1,
“Target”: “glad happy pleased over the moon”,
“Condition”: “ ”,
“Markup”: “#HappyModerate &S #HappyOff”
I'm so glad you're here→#HappyModerate I'm so glad you're here #HappyOff.

### PRIORITY

Rules may optionally include priority values, which define a priority of which rules are applied when rules conflict. For example, a lower value may denote a higher priority in a rule hierarchy: e.g. where a priority 1 and priority 2 rule conflict, the priority 1 rule is executed preferentially. The priority field thus creates a rule hierarchy. Examples of possible conflicts include: two rules executing a punctual gesture on the same word, or two instances of the same punctual gesture occurring in quick succession, where the second instance is called before the first has reached completion.

### Conditions

A Rule may be optionally associated with a Condition which limits the applicability of the Rule. Examples of conditions include: part of speech, polarity, connotation, or position of a target in a sentence. If populated, the Condition of a Rule may contain a function, or combination of functions, which will return a TRUE or FALSE value, depending on whether the condition is satisfied. If multiple functions are to be used, these can be combined using logical AND or OR commands. In other words, a Rule is only applied if its Condition (if any) is met. Examples of Conditions include (but are not limited to):
Dictionary Conditions, wherein A “Contains Keyword” Condition may be associated with a Rule such that the Rule is only applied if one or more Dictionary terms appear in an utterance.
a “First Word Condition” wherein Rules with “First word” conditions are applied if the specified target is the first word in the sentence,
Negative Polarity Condition, wherein Rules with negative polarity Conditions are applied if the Communicative Utterance that contains the specified target has a negative polarity.
Next Word Condition, which takes the target and sentence as input, and returns true if the next word in the sentence after the target word matches the wordToFind parameter.
Part of Speech condition takes the target, sentence and partOfSpeechTag as input, and returns true if the target matches the tag which represents a part of speech.

Dictionary

A Dictionary-based approach may enable the application of Behaviour Modifiers and/or Elegant Variation to dialogue at scale. A Dictionary is a collection of words or phrases of similar sentiment, to which the same Behaviour Modifiers should be applied. A Dictionary allows the same Markup (including any specified Elegant Variation) to be applied to a collection of Targets. A Dictionary may be used to specify custom Markup to the Embodied Agent's expression of corpus content. A Dictionary may apply Markup to a large number of targets (such as words, phrases or sentences), without the need to clutter the corpus content Tag, or require several Rules, which may be difficult to maintain and subject to change. Instead, a single Rule may refer to a Dictionary. More than one Dictionary may be defined, and each Dictionary may encompasses a unique markup effect. For example, a positive association Dictionary, a negative association Dictionary, and a technical language Dictionary can all be developed for a single Corpus, and can even overlap in their content. Examples of Dictionaries are as follows:

| Technical association | Positive Association | Negative Association |
|---|---|---|
| dictionary | Dictionary | Dictionary |
| Digital Human | Smile | Sad |
| Avatar | Happy | Sorry |
| Artificial Intelligence | Joy | Annoying |
| Neural Network | Delighted | Stupid |
| Virtual Nervous System | Wonderful | Boring |
| Human Computing | Fantastic | Unfortunate |

In one embodiment, dictionaries are text files containing words or phrases that have the same sentiment. When a dictionary word is matched, the rule may apply Markup to the word itself, or to the entire sentence.

A Rule which references the Positive Association dictionary, applying moderate happy to the sentence containing any dictionary entry may be defined as follows:
“Description”: “Positive Association Rule”,
“Priority”: 1,
“Target”: “&FUNCTION”,
“TargetFunction” “@KEYWORDMATCH(&S, \“PositiveAssociation\”)”,
“Condition”: “@CONTAINSKEYWORD(&S,\“PositiveAssociation\”)”,
“Markup”: “#HappyModerateOn &S #HappyModerateOff”

In one embodiment, a “universal dictionary” is provided, such that dictionary entries comprise or are associated with sentiments instead of literal words. Any suitable method of sentiment analysis may be employed.

Rule Processor

A Rule Processor processes Communicative Utterances in real-time, identifies and applies Rules to modify Communicative Utterances. The Rule Processor applies Markup to text according to rules, processes the Markup and maps between high and low level markup tags. For each Communicative Utterance, the Rule Processor checks Communicative Utterance against each of the Rules, and applies relevant Markup. The Rule Processor processes every Communicative Utterance, one by one. The output of the Rule Processor may be sent to a TTS & animation (or physical actuation) system.

Conflict Resolution

The Rule Processor may resolve conflict where two or more applicable Rules conflict. The Rule Processor may apply the Rule having the highest priority, and disregard any lower-priority conflicting rules.

Multiple-Parsing of Communicative Utterances

In one embodiment, the Rule Processor is configured to execute multiple sequential parses of a Communicative Utterance. This may be useful, for example, where the Result (output) of a Rule is a Target for another Rule. In one embodiment, Communicative Utterances are processed and re-processed through Rule Processor executes multiple sequential parses until no new Rules are applicable. In another embodiment, the Rule Processor executes a set number of sequential parses. In another embodiment, the Rule Processor executes two sequential parses, whereas the first parse is configured to generate any Elegant Variations, and the second parse is configured to apply any Behaviour Modifiers to the generated Elegant Variation.

In one embodiment, each “pass” is a twostep process. First, a “Mark-Up Pass” resolves any Markup requiring resolution (such to select an Alternative Variant from Elegant Variation-related Markup in the corpus). Second, a “Rules Pass” searches for rules applicable to the resolved Communicative Utterance.

Translation to Low level Markup

The Rule Processor also translates high level Markup (e.g. Markup tags) to low-level markup which can be executed by a speech and/or animation generating system. A function may convert the Markup into low-level animation information. E.g.: Smile>→[AU12lipcornerpuller,0,0,1,0.5,2,0]. Markup may be recognized and readable by a low-level agent behaviour generator, such as that described in U.S. Ser. No. 10/181,213B2 titled “A system for Neurobehavioural Animation”, incorporated by reference herein. High Level markup tags may be configured to be human-understandable.

In one embodiment, high level Markup comprises TTS tags, which are specified within runtime data and map to animation definitions such as Action Units (AUs), and numeric values which determine the timing and intensity of the TTS tag activation. A pattern <time, intensity> can be repeated multiple times to form data points that are linearly interpolated between to create an animation curve. Increasing the number of data points creates a smoother animation curve. Intensity values may be normalized. Low level tags may be defined in runtime.

The peak movement of the gesture may be aligned with an acoustic feature, such as the first stressed syllable of the word that follows the gesture tag. For example, for a nod during word “fantastic”, w the downward stroke of the nod (the peak movement) may be aligned with the first syllable “tas” (the first stressed syllable) of the word “fantastic”: [!tag,htiming offseti,hintensityi,hsyllable alignmenti]→e.g. [!gestureNod,−0.6,1,−1]
Tags used with this syntax are all short duration animations.
The timing offset (in seconds) is the time between the start of the animation and its peak. It is unique per animation. The value is negative as the animation will need to be shifted backwards in time.
The intensity, as for intensities using the general form, is normalised
The stressed syllable can either take the value −1, the default, which chooses the first stressed syllable of the word as defined in the TTS dictionary; or an integer that manually specifies the syllable according to zero-based indexing.

Gesture files may contain the translations from high-level to low-level markup, including timing and intensity for each gesture. Gesture Files may also be externally loaded (such as a json) so they are simple to edit and update, e.g.:

{
“Name”: “HappyModerateOn”,
“Markup”: “[AU06cheekraiser,0,0,0.5,0.25][AU12lipcornerpuller,0,0,0.5,0.3]”
},
{
“Name”: “HappyModerateOff”,
“Markup”:
“[AU06cheekraiser,0,0.25,0.5,0.25,0.75,0.08,1,0.03,1.25,0][AU12lipcornerpuller,0,0.3,0.5,0.3,0.75,
0.1,1,0.03,1.25,0]” }

Markup

Markup denotes the application of Elegant Variation and/or Behaviour Modifiers to a Communicative Utterance. In one embodiment, Markup comprises Tags which are added to a representation of the Communicative Utterance. A Corpus may include Markup which has been manually authored or otherwise pre-assigned to the Corpus. Alternatively and/or additionally, as described in further detail above, a Rule Processor automatically applies Markup in real-time during live operation of an agent.

Short Term Tags

Short Term Tags are open tag/closing tag pairs which encapsulate the Communicative Utterance to which the Tags are to be applied. Behaviour Modifiers are retained from when an open Tag is encountered until a closing Tag is encountered. For example, Short Term Tags are used to apply Behaviour Modifiers in the form of short term facial expression such as to communicate a particular emotion, that can last from one to two words, to an entire sentence. In one example embodiment, a “#” symbol is used to apply on and off tags. In this embodiment, The Communicative Utterance “Hello my name is Rachel” may include Markup to apply the Behaviour Modifier of a “moderately happy” expression, using Tags as follows:
#HappyModerateOn Hello my name is Rachel #HappyModerateOff
#QuestionSlightOn How can I help you #QuestionSlightOff?

Applying an emotion to a phrase:
Hi, I'm Rachel and I'm #HappyStrongOn really happy to be here #HappyStrongOff.
You look #CompassionSlightOn a bit confused #CompassionSlightOff is there something I can do?

Applying multiple emotions per sentence:
#SadModerateOn I'm sorry I didn't hear that #SadModerateOff, #QuestionModerateOn can you try again
   #QuestionModerateOff

Long Term Tags

Permanent Behaviour Modifiers such as Moods may be set by Long Term Tags when apply long-term Behaviour Modifiers to the agent. Moods may include emotional states, such as happy, concerned and sad. Moods may span multiple sentences, change based on dialogue content or a human user's mood.

Behaviour Modifiers

Behaviour Modifiers refer to how Communicative Utterances are expressed, and may be defined using Markup. Behaviour Modifiers may define any aspect of how Communicative Utterances are communicated, such as how they sound, or which gestures or body language accompany the Communicative Utterances. Behaviour Modifiers may modify audio output, such as Intonation, Amplitude, Speed of speech delivery. A Rule may output Markup which amplifies any existing signals. For example, if an utterance ends in an exclamation, perform emphasis gestures more strongly, amplify current emotion. Behaviour Modifiers may modify the expression of motor actions, such as:
Tonic motor states (constant facial expressions indicating mood, a position of the eyelids indicating tiredness. Such changes alter states slowly, and endure for some time.
Speed of gesture delivery
Actions (discrete motor programs that can be “performed” at particular times and take a set amount of time to execute. These include communicative actions as well as speech-related actions, which accompany speech and can be thought of as the visible reflexes of speaking.

Punctual Gestures are finite duration movements which are useful for emphasis. These may be Facial expressions that can last from one to two words, to an entire sentence. Communicative Affect Gestures are Short term facial expression to communicate a particular emotion. Facial expressions that can last from one to two words, to an entire sentence. Punctual Gestures can include affects such as smiles, brow furrows and brow raises. Examples include: Head shake (left and right), Head tilt (left and right), Head nod, Brow raise, Brow furrow, blink, eye widen, eye narrow, smile. Punctual gesture tags may be placed immediately before the word to which they apply. There is no stop tag as these gestures are finite in duration.

Referral gestures may be used when the Embodied Agent needs to refer to some location in the environment e.g. some visual material to the side, a chat window below etc. Like the emotional Tags above, Referral Gestures may also have a start and a stop tags. Timing Tags add a pause in speech of the length specified in the tag name i.e. half a second, one second etc.

Personality

The Embodied Agent's personality may be manifested through meta-level dialogue acts. Different sets of meta-level models may realize different personalities (polite, informal, millennial, etc). Different sets of Rules may correspond to different personality types. The type and/or intensity of Behaviour Modifiers may be varied according to personality.

Responding to User Behaviour

Emotion and/or other feedback from a user could serve to alter Agent dialogue and/or induce communicative gestures. For example, is a face present? Is a user paying attention? The Rule Processor may be configured to apply Markup according to user behaviour or other contextual factors. For example, Markup strings may be activated when a user's emotional state passes a certain threshold. User emotional responses or other feedback can be used to automatically tune the dialogue system and amend Rules. For instance, where the system has a range of options.

Elegant Variation

Elegant Variations are different versions of a Communicative Utterance. Variation in an agent's speech prevents the conversation from becoming repetitive, and may be particularly useful for common phrases like greetings and fallbacks. A simple grammar is defined for each utterance type. In one embodiment, a tree-like structure is specified, wherein sibling nodes represent alternatives (which may include a lack of expression). An example of a grammar for an elegant variation greeting is:
{Hi|Hello|Hey}{there|}. {It's{very|really} nice to {see|meet} you.|} {How are you?|}

Different wording options are contained within curly braces, separated by a vertical bar. For example, to begin the greeting, one of “hi, hello, hey is chosen at random. ‘There’ is optionally inclusive, denoted by the vertical bar followed by a blank space—thus either ‘there’ or ‘nothing’ is selected. Similarly, the “how are you?” is optional.

The following utterances may be generated from the above (amongst others):
Hi. It's really nice to meet you.
Hey there. How are you?
Hello. It's very nice to see you.
Hi there. It's nice to meet you. How are you?

Elegant Variations with Non-Verbal Utterances

The Elegant Variation grammar may include non-verbal utterances, defined using Markup as described herein. For example: {Mm-hmm|Right|Yup}[{#UNDERSTAND-NOD|#UNDERSTAND-DOUBLE-NOD} [#CLOSEEYES]]}. This string can produce either Mm-hmm, Right or Yup, accompanied optionally by an understanding nod, or an understanding double nod, both of which can optionally be accompanied by a brief closing of the eyes.

Weightings

Weightings for each node may be specified. For instance {A 1|B 5} generates B 5 times more frequently than A. Weightings may be automatically adjusted over time. For example, positive responses of a user to a given variant may result in increments to weights of the choices that yielded the positive response, and vice versa for negative responses.

Recursive Descent Parser

To process and return an Elegant Variation, a recursive algorithm may be used. The following pseudocode shows one example implementation:

```
function elegant-variation(input-string) [returns output-string]
- output-string==“”
- pointer==0
- repeat until pointer is length(input-string):
{
%If you come across the start of a {...} expression..
- if string[pointer] = “{“
  {
  %Step through the whole expression - including nested { }s - recording top-level options in
  %a list (options-list)
  - pointer++
  - num-open-brackets==1
  - options-list==[“”] (a list containing a single empty string)
  - option-number==0 %This indicates the ‘active’ string in the options-list
  - repeat until num-open-brackets is 0:
    - if input-string[pointer] = “{“ then num-open-brackets++
    - if input-string[pointer] = “}” then num-open-brackets−−
    - if num-open-brackets < 0 then error(“too many }s in input-string”)
    - if pointer = length(input-string) then error(“too many {s in input-string”)
    %If you reach a top-level “|” symbol..
    - if num-open-brackets = 1 and input-string[pointer]=“|”
      {
      % increase the option number, and initialise an empty string at this position in the options list
      - option-number++
      - options-list[option-number] == “”
      }
      - else
      %Else add the symbol at the current pointer position to the active string
      - add-to-end(options-list[option-number], input-string[pointer])
    - pointer++
    }
    %Choose one of the strings in options-list..
    - chosen-string==random-pick(options-list)
    %Then recursively run elegant-variation on that chosen string..
    - **processed-chosen-string==elegant-variation(chosen-string)
    %Then add the result to output-string..
    - output-string==concatenate(output-string,processed-chosen-string)
    }
  - else
    - add-to-end(output-string, input-string[pointer])
- pointer++
}
- return(output-string)
```

In one embodiment, the Rule Processor may include a memory, such that when elegant variations are generated, the same variant is never generated twice in a row.

In one embodiment, Elegant Variations are produced by selecting a random combination of two sets. For instance, the notation [gesture1|gesture 2] [text1|text2] applies a randomly selected gesture with randomly selected text. A dictionary may be treated as a set of utterances to be selected from at random and combined with a randomly selected gesture.

Unified Animation Space

A unified animation space is provided to reconcile a plurality of animation inputs. Animation input may arrive from several sources, including but not limited to:
Pre-recorded animation
Autonomous animation from a virtual central nervous system
Lip synchronization animation

The one or more animation inputs may all be in a unified animation space (or translated to a unified animation space) such that the animation inputs can be linearly combined.

In in embodiment, animation inputs in a FACS space, are added linearly together. For example

w_all=alpha_recorded+w_recored+alpha_cns+w_cns+alpha_lip+w_lip

In order to filter out conflicting animations (for example, the avatar is crying while trying to speak), a control layer determines which animation signals goes through. A method of controlling conflicting animation is disclosed in NZ747627, “Morph Target Animation”, and NZ750233, and “Real-time generation of speech animation”, incorporated by reference herein.

This control layer adjust weightings (alpha values). For example, if the avatar is speaking, only the “jawopen” signal from lip synchronization animations passes through the control layer, whereas jawopen from other sources will be suppressed (alpha_lip=1.0, alpha_recorded=0.0, alpha_cns=0.0). The control logic is carefully crafted for each FACS channels from each input sources, to give the most desirable behaviour.

While these signals are linearly superimposed in the animation space, they are nonlinear in the deformation space. This nonlinearity in the deformation space is caused by the nonlinear blending of the blendshape interpolation system (through the addition of combination and incremental shapes). Therefore, despite the linear addition of the animation weights, the resulting deformation can be complex and realistic.

Top-Down and Bottom-Up Control

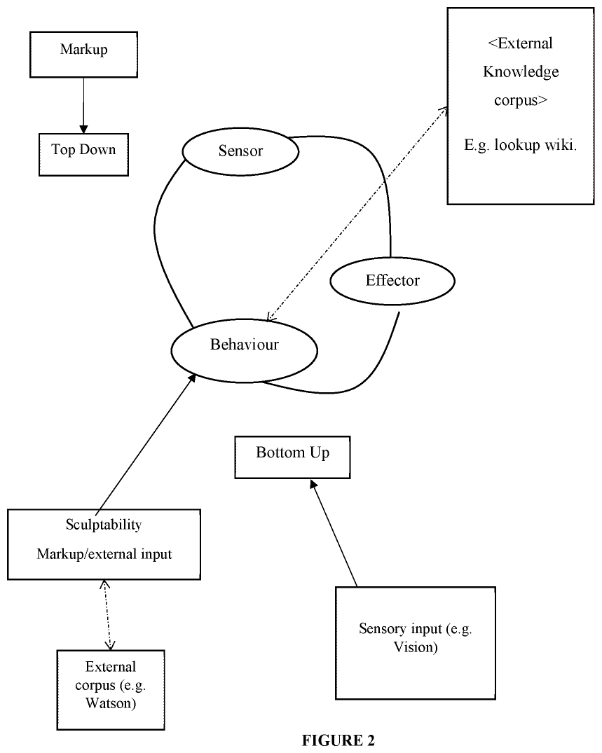

FIG. 2 shows a system for bottom-up and top-down control of Embodied Agent behaviour. In one embodiment, Embodied Agents are autonomous dynamic systems, with self-driven behaviour, which can also be controlled (in a weighted fashion) externally by Markup as described herein, allowing a blend of autonomy and directability.

“Bottom up” autonomous behaviour may be facilitated by a programming environment such as that described in the patent U.S. Ser. No. 10/181,213B2 titled “System for Neurobehavioural Animation”. A plurality of Modules are arranged in a required structure and each module has at least one Variable and is associated with at least one Connector. The connectors link variables between modules across the structure, and the modules together provide a neurobehavioral model. Each Module is a self-contained black box which can carry out any suitable computation and represent or simulate any suitable element, such as a single neuron, to a network of neurons or a communication system. The inputs and outputs of each Module are exposed as a Module's Variables which can be used to drive behaviour (and in graphically animated Embodied Agents, drive the Embodied Agent's animation parameters). Connectors may represent nerves and communicate Variables between different Modules. The Programming Environment supports control of cognition and behaviour through a set of neurally plausible, distributed mechanisms because no single control script exists to execute a sequence of instructions to modules.

In one embodiment, the Rules may provide input to the neurobehavioural model. For example, long-term emotional states may be triggered by affecting the mood of an Embodied Agent by setting or modulating a neurochemical state of the embodied agent. In one embodiment, there is provided a method for animating a Embodied Agent including the steps of: receiving a Communicative Utterance; processing the Communicative Utterance to identify one or more Rules applicable to at least one Target in the Communicative Utterance; wherein the effect of the rule is to modulate an internal state of the Embodied Agent. The degree of modulation of the internal state of the embodied agent (e.g. virtual character, digital entity or robot) may depend on an autonomy variable, wherein a higher value of the autonomy variable decreases the modulation of the internal state by the rule.

### Advantageous Effects

A Markup System automatically applies Behaviour Modifier (such as gestures, expressions and mood states) to Text to be delivered by an Embodied Agent. Embodiments described reduce the need for manual labour to Markup Corpus content. Behaviour Modifiers and Elegant Variations may be applied in a uniform manner to both verbal or non-verbal communication. Both general and domain-specific mark-up may be added in a simple and scalable manner. The Markup System allows for variation in Rule applied to different Embodied Agents or in different situations, thus making Embodied Agent personalities readily adaptable.

### INTERPRETATION

The methods and systems described may be utilised on any suitable electronic computing system. According to the embodiments described below, an electronic computing system utilises the methodology of the invention using various modules and engines. The electronic computing system may include at least one processor, one or more memory devices or an interface for connection to one or more memory devices, input and output interfaces for connection to external devices in order to enable the system to receive and operate upon instructions from one or more users or external systems, a data bus for internal and external communications between the various components, and a suitable power supply. Further, the electronic computing system may include one or more communication devices (wired or wireless) for communicating with external and internal devices, and one or more input/output devices, such as a display, pointing device, keyboard or printing device. The processor is arranged to perform the steps of a program stored as program instructions within the memory device. The program instructions enable the various methods of performing the invention as described herein to be performed. The program instructions, may be developed or implemented using any suitable software programming language and toolkit, such as, for example, a C-based language and compiler. Further, the program instructions may be stored in any suitable manner such that they can be transferred to the memory device or read by the processor, such as, for example, being stored on a computer readable medium. The computer readable medium may be any suitable medium for tangibly storing the program instructions, such as, for example, solid state memory, magnetic tape, a compact disc (CD-ROM or CD-R/W), memory card, flash memory, optical disc, magnetic disc or any other suitable computer readable medium. The electronic computing system is arranged to be in communication with data storage systems or devices (for example, external data storage systems or devices) in order to retrieve the relevant data. It will be understood that the system herein described includes one or more elements that are arranged to perform the various functions and methods as described herein. The embodiments herein described are aimed at providing the reader with examples of how various modules and/or engines that make up the elements of the system may be interconnected to enable the functions to be implemented. Further, the embodiments of the description explain, in system related detail, how the steps of the herein described method may be performed. The conceptual diagrams are provided to indicate to the reader how the various data elements are processed at different stages by the various different modules and/or engines. It will be understood that the arrangement and construction of the modules or engines may be adapted accordingly depending on system and user requirements so that various functions may be performed by different modules or engines to those described herein, and that certain modules or engines may be combined into single modules or engines. It will be understood that the modules and/or engines described may be implemented and provided with instructions using any suitable form of technology. For example, the modules or engines may be implemented or created using any suitable software code written in any suitable language, where the code is then compiled to produce an executable program that may be run on any suitable computing system. Alternatively, or in conjunction with the executable program, the modules or engines may be implemented using, any suitable mixture of hardware, firmware and software. For example, portions of the modules may be implemented using an application specific integrated circuit (ASIC), a system-on-a-chip (SoC), field programmable gate arrays (FPGA) or any other suitable adaptable or programmable processing device. The methods described herein may be implemented using a general-purpose computing system specifically programmed to perform the described steps. Alternatively, the methods described herein may be implemented using a specific electronic computer system such as a data sorting and visualisation computer, a database query computer, a graphical analysis computer, a data analysis computer, a manufacturing data analysis computer, a business intelligence computer, an artificial intelligence computer system etc., where the computer has been specifically adapted to perform the described steps on specific data captured from an environment associated with a particular field.

### SUMMARY OF INVENTION

In one embodiment, there is provided: A method for animating an Embodied Agent, including the steps of: receiving a Communicative Utterance; processing the Communicative Utterance to generate an Elegant Variation of the Communicative Utterance; processing the Elegant Variation to identify one or more Rules applicable to at least one Target in the Elegant Variation; applying Markup to the representation of the Elegant Variation of the Communicative Utterance according to the one or more Rules, wherein the Markup defines one or more Behaviour Modifiers configured to modify how the Communicative Utterance is expressed; processing the Markup to apply Behaviour Modifiers as the Embodied Agent expresses the Communicative Utterance.

Optionally, one or more Rules are associated with a priority, the method including the steps of resolving conflict between rules by only applying the Rule having the highest priority where two or more Rules conflict.

Optionally, Behaviour Modifiers include: facial expressions, body language and/or voice intonation.

Optionally, Communicative Utterance include verbal utterances and gestural utterances.

Optionally, one or more Rules refer to a dictionary of Targets to which the Rules apply.

Optionally, Markup defining the one or more Behaviour Modifier is translated to a lower-level representation for controlling the Embodied Agent.

In another embodiment, there is provided: A method for animating a Embodied Agent including the steps of: receiving a Communicative Utterance; processing the Communicative Utterance to identify one or more Rules applicable to at least one Target in the Communicative Utterance; wherein the effect of the rule is to modulate an internal state of the Embodied Agent.

Optionally, the degree of modulation of the internal state of the Embodied Agent depends on an autonomy variable, wherein a higher value of the autonomy variable decreases the modulation of the internal state.

In another embodiment, there is provided: A method for generating an Elegant Variation of a Communicative Utterance for communication by a Embodied Agent, including the steps of: defining a grammar for the Communicative Utterance by embedding the definition of the grammar as an annotated representation of the Communicative Utterance; the annotated representation including: at least one sub-expression nesting a plurality of Alternative Variants; at least one of the Alternative Variants nesting a plurality of Alternative Variants; generating an Elegant Variation from the context-free grammar.

Optionally, one of the alternatives from at least one of the plurality of alternatives is an absence of expression.

Optionally, one or more of the sub-expressions represent verbal communication.

Optionally, one or more of the sub-expressions represent gestural communication.

Optionally, gestural communications are represented by Markup Tags.

Optionally, the annotated representation is a text-based representation with nesting represented parenthetically.

Optionally, the Alternative Variants are associated with weights, wherein the weights represent a probability of selection relative to the other Alternative Variants.

In another embodiment, there is provided: A method for controlling an expression of a Communicative Utterance by a Embodied Agent, including the steps of: receiving a representation of the Communicative Utterance; receiving a plurality of Rules including: Targets to which the rules are to be applied; Conditions which limit application of the rules; Results which define Markup for a modification of the Communicative Utterance and/or a manner of delivery of the Communicative Utterance; applying one or more of the plurality of Rules to generated a Marked-Up communicative utterance; and processing the Marked-Up communicative utterance to control the behaviour of the Embodied Agent as the Embodied Agent expresses the Communicative Utterance.

1. A method for animating an Embodied Agent, including the steps of:
receiving a Communicative Utterance;
processing the Communicative Utterance to generate an Elegant Variation of the Communicative Utterance;
processing the Elegant Variation to identify one or more Rules applicable to at least one Target in the Elegant Variation;
applying Markup to the representation of the Elegant Variation of the Communicative Utterance according to the one or more Rules, wherein the Markup defines one or more Behaviour Modifiers configured to modify how the Communicative Utterance is expressed;
processing the Markup to apply Behaviour Modifiers as the Embodied Agent expresses the Communicative Utterance.

2. The method of claim 1 wherein the representation of the Elegant Variation is generated using the method generating an Elegant Variation of a Communicative Utterance for communication by a Embodied Agent, including the steps of:
defining a grammar for the Communicative Utterance by embedding the definition of the grammar as an annotated representation of the Communicative Utterance;
the annotated representation including:
at least one sub-expression nesting a plurality of Alternative Variants; at least one of the Alternative Variants nesting a plurality of Alternative Variants; generating an Elegant Variation from the context-free grammar.

3. The method of claim 1 wherein the one or more Rules are associated with a priority, the method including the steps of resolving conflict between rules by only applying the Rule having the highest priority where two or more Rules conflict.

4. The method of claim 1 wherein Behaviour Modifiers include: facial expressions, body language and/or voice intonation.

5. The method of claim 1 wherein Communicative Utterance include verbal utterances and gestural utterances.

6. The method of claim 1 wherein one or more Rules refer to a dictionary of Targets to which the Rules apply.

7. The method of claim 1 wherein Markup defining the one or more Behaviour Modifier is translated to a lower-level representation for controlling the Embodied Agent.

8. A method for animating a Embodied Agent, wherein the Embodied Agent is a dynamic system comprising an internal, configured to drive the Embodied Agent's animation parameters, including the steps of:
receiving a Communicative Utterance;
processing the Communicative Utterance to identify one or more Rules applicable to at least one Target in the Communicative Utterance;
wherein the effect of the rule is to modulate the internal state of the Embodied Agent.

9. The method of claim 8 wherein the degree of modulation of the internal state of the Embodied Agent depends on an autonomy variable, wherein a higher value of the autonomy variable decreases the modulation of the internal state.

10. A method for generating an Elegant Variation of a Communicative Utterance for communication by a Embodied Agent, including the steps of:
defining a grammar for the Communicative Utterance by embedding the definition of the grammar as an annotated representation of the Communicative Utterance;
the annotated representation including:
at least one sub-expression nesting a plurality of Alternative Variants; at least one of the Alternative Variants nesting a plurality of Alternative Variants;
generating an Elegant Variation from the grammar.

11. The method of claim 10 wherein one of the alternatives from at least one of the plurality of alternatives is an absence of expression.

12. The method of claim 10 wherein one or more of the sub-expressions represent verbal communication.

13. The method of claim 10 wherein one or more of the sub-expressions represent gestural communication.

14. The method of claim 13 wherein gestural communications are represented by Markup Tags.

15. The method of claim 10 wherein the annotated representation is a text-based representation with nesting represented parenthetically.

16. The method of claim 10 wherein the Alternative Variants are associated with weights, wherein the weights represent a probability of selection relative to the other Alternative Variants.

17. A method for controlling an expression of a Communicative Utterance by a Embodied Agent, including the steps of:
receiving a representation of the Communicative Utterance;
receiving a plurality of Rules including:
Targets to which the rules are to be applied;
Conditions which limit application of the rules;
Results which define Markup for a modification of the Communicative Utterance and/or a manner of delivery of the Communicative Utterance;
applying one or more of the plurality of Rules to generated a Marked-Up communicative utterance; and
processing the Marked-Up communicative utterance to control the behaviour of the Embodied Agent as the Embodied Agent expresses the Communicative Utterance.
